(19) United States
(12) Patent Application Publication
(10) Pub. No.: US 2020/0033439 A1
(43) Pub. Date: Jan. 30, 2020

(54) MULTI-ALGORITHM TRILATERATION SYSTEM

(71) Applicant: Johnson Controls Technology Company, Auburn Hills, MI (US)

(72) Inventors: Donagh S. Horgan, Cork (IE); Michael G. Cronin, Crosshaven (IE); James B. Hurley, Knocknamarriff (IE); Graham M. Baitson, Ballymun (IE)

(21) Appl. No.: 16/452,970

(22) Filed: Jun. 26, 2019

Related U.S. Application Data
(60) Provisional application No. 62/702,838, filed on Jul. 24, 2018.

(51) Int. Cl. G01S 5/02; G01S 5/14

(52) U.S. Cl. CPC G01S 5/0268; G01S 5/14

(57) ABSTRACT

An illustrative embodiment disclosed herein is a system including client devices distributed across an environment and configured to generate distance measurements. The system further includes wireless transceivers. Each transceiver is associated with one of the client devices. Each transceiver is configured to send and receive distance measurements. The system further includes a trilateration circuit in at least one of the client devices. The trilateration circuit is configured to receive the distance measurements from the client devices, determine a first position and a first weight based on the distance measurements via a first algorithm, determine second position and a second weight based on the second distance measurements via a second algorithm, calculate a final position based on the first position, the second position, the first weight, and the second weight, and send the final position to the plurality of client devices.

### CROSS-REFERENCE TO RELATED APPLICATION

This application is related to and claims priority under 35 U.S. § 119(e) from U.S. Patent Application No. 62/702,838, filed Jul. 24, 2018, titled “MULTI-ALGORITHM TRILATERATION SYSTEM,” the entire contents of which are incorporated herein by reference for all purposes.

### BACKGROUND

The present disclosure relates generally to a trilateration system and more particularly to a trilateration system for locating a plurality of client devices distributed across a building or other environment.

In geometry, trilateration is the process of determining absolute or relative locations of points by measurement of distances, using the geometry of circles, spheres or triangles. The problem of solving these is a trivial matter when the distance measurements are perfectly accurate. In real world applications, this is rarely the case and depending on the relative locations of the centers even a small amount of noise can result in a lot of uncertainty in the real location.

### SUMMARY

Aspects of the present disclosure relate generally to trilateration location tracking, and more particularly to a system and method to improve the accuracy of trilateration location tracking using the combination of multiple algorithms and a windowing technique.

An illustrative embodiment disclosed herein is a system including a plurality of client devices distributed across an environment and configured to generate distance measurements. The system further includes a plurality of wireless transceivers. Each transceiver is associated with one of the plurality of client devices. Each transceiver is configured to send and receive distance measurements. The system further includes a trilateration circuit in at least one of the plurality of the client devices. The trilateration circuit is configured to receive the distance measurements from the client devices, determine a first position and a first weight based on the distance measurements via a first algorithm, determine second position and a second weight based on the second distance measurements via a second algorithm, calculate a final position based on the first position, the second position, the first weight, and the second weight, and send the final position to the plurality of client devices.

In some embodiments, determining the first position and determining the second position are in response to determining an absence of an exact fit solution.

In some embodiments, the first weight is based on a first certainty level, and the second weight based on a second certainty level.

In some embodiments, the first weight is proportional to the first certainty level, the second weight is proportional to the second certainty level, and a sum of the first weight and the second weight is equal to a value of one.

In some embodiments, the trilateration circuit further configured to receive a plurality of live distance measurements from a plurality of second client devices distributed across a second environment, determine a third position and a third weight via the first algorithm, determine a fourth position and a fourth weight via the second algorithm, update the first weight based on the third weight, update the third weight based on the fourth weight, and calculate a second final position of the second environment. In some embodiments, calculating the second final position of the second environment is based on the third position, the fourth position, the updated first weight and the updated second weight.

In some embodiments, the plurality of base distance measurements includes raw data samples of a first one of the plurality of client devices. In some embodiments, each of the raw data samples are measured at different times. In some embodiments, the trilateration circuit is further configured to select a window of the raw data samples in response to receiving the raw data samples from the first one of the plurality of client devices.

In some embodiments, the selecting the window of the raw data samples includes determining a first median value of a first subset of the raw data samples, determining a second median value of a second subset of the raw data samples, and selecting from the first one of the plurality of client devices only the first subset of the raw data samples. In some embodiments, selecting from the first one of the plurality of client devices only the first subset of the raw data samples is in response to a difference between the second median value and the first median value being less than a pre-determined value.

In some embodiments, the calculating includes determining a first weighted position by multiplying the first position by the first weight, determining a second weighted position by multiplying the second position by the second weight, and calculating a sum of the first weighted position and the second weighted position.

In some embodiments, the first algorithm includes a clustering algorithm and the second algorithm includes a linear regression algorithm.

Another illustrative embodiment disclosed herein is a method, by a trilateration circuit, including receiving a plurality of base distance measurements from a plurality of client devices distributed across a first environment, determining a first position and a first weight based on the plurality of base distance measurements via a first algorithm, determining a second position and a second weight based on the plurality of base distance measurements via a second algorithm, calculating a final position based on the first position, the second position, the first weight, and the second weight, and sending the final position to the plurality of client devices.

In some embodiments, the method further includes the determining the first position and determining the second position are in response to determining an absence of an exact fit solution.

In some embodiments, the first weight is based on a first certainty level, and the second weight is based on a second certainty level.

In some embodiments, the first weight is proportional to the first certainty level, the second weight is proportional to the second certainty level, and a sum of the first weight and the second weight is equal to a value of one.

In some embodiments, the method further includes receiving a plurality of live distance measurements from a plurality of second client devices in a second environment, determining a third position and a third weight via the first algorithm, determining a fourth position and a fourth weight via the second algorithm updating the first weight based on the third weight updating the third weight based on the fourth weight, and calculating a second final position based on the third position, the fourth position, the updated first weight and the updated second weight.

In some embodiments, the plurality of base distance measurements includes raw data samples of a first one of the plurality of client devices. In some embodiments, each of the raw data samples are measured at different times. In some embodiments, the method further includes selecting a window of the raw data samples in response to receiving the raw data samples from the first one of the plurality of client devices.

In some embodiments, the selecting the window of the raw data samples includes determining a first median value of a first subset of the raw data samples, determining a second median value of a second subset of the raw data samples, and selecting from the first one of the plurality of client devices only the first subset of the raw data samples. In some embodiments, selecting from one of the plurality of client devices only the first subset of the raw data samples is in response to a difference between the second median value and the first median value being less than a pre-determined value.

In some embodiments, the calculating includes, determining a first weighted position by multiplying the first position by the first weight, determining a second weighted position by multiplying the second position by the second weight, and calculating a sum of the first weighted position and the second weighted position. In some embodiments, the first algorithm includes a clustering algorithm and the second algorithm includes a linear regression algorithm.

Another illustrative embodiment disclosed herein is a system including a plurality of client devices distributed across an environment and configured to generate distance measurements. The system further includes a plurality of wireless transceivers. Each transceiver is associated with one of the plurality of client devices. Each transceiver is configured to send and receive distance measurements. The system further includes a trilateration circuit in at least one of the plurality of the client devices. The trilateration circuit is configured to receive the distance measurements from the client devices, determine a plurality of positions and a plurality of weights based on the distance measurements via a plurality of algorithms, calculate a final position based on the plurality of positions and the plurality of weights, and send the final position to the plurality of client devices.

In some embodiments, determining plurality of positions is in response to determining an absence of an exact fit solution.

Further details of aspects, objects, and advantages of the systems and methods described herein are provided below in the detailed description, drawings, and claims. Both the foregoing general description and the following detailed description are exemplary and explanatory, and are not intended to be limiting as to the scope of the systems and methods described herein. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates trilateration in a noiseless system.

FIG. 1B illustrates trilateration in a noisy system.

FIG. 2 illustrates an embodiment of a centralized location tracking system.

FIG. 3 illustrates an embodiment of a distributed location tracking system.

FIG. 4 illustrates an embodiment of a client device.

FIG. 5 illustrates an example method of combining different trilateration techniques.

FIG. 6A graphically illustrates subsets of raw data samples, each having a different size.

FIG. 6B graphically illustrates subsets of raw data samples, each having a different starting sample.

FIG. 7 illustrates an example method of windowing.

FIG. 8 illustrates an example method of calculating the final position.

FIG. 9 illustrates an example method of using weights of a first environment in a second environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

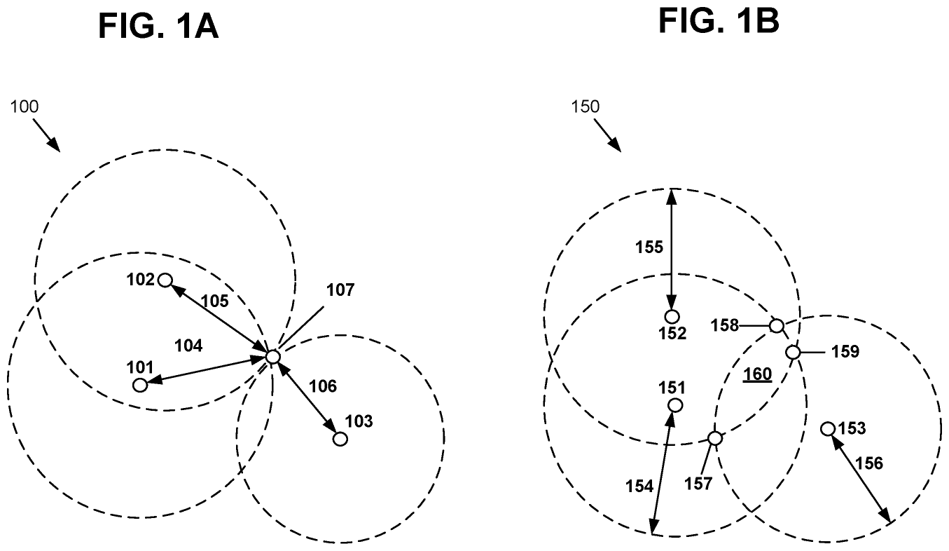

The trilateration technique can be used in both two and three-dimensional spaces and is used for Global Positioning Systems (GPS) to accurately determine locations on the ground. A single distance measurement to a known location means that point lies on a circular perimeter around the known point. The trilateration technique relies on the accurate measurement to at least three known positions to find a unique location. FIG. 1A illustrates trilateration in a noiseless system 100. Three distance measuring devices 101, 102, and 103 are defined as centers of three circles. The distance measurements 104, 105, and 106 to a location being tracked 107 are defined as radii of the three circles. The location being tracked 107, can be found where the three circles intersect.

In real-world applications, the accuracy of trilateration technique is impacted by noise. This limits the accuracy of the technique and results in poor estimations of the location being tracked 107. FIG. 1B illustrates trilateration in a noisy system 150. Three distance measuring devices 151, 152, and 153 are defined as centers of three circles. The distance measurements 154, 155, and 156 to a location being tracked 160 are defined as radii of the three circles. The three circles intersect at points 157, 158, and 159. Thus, the estimation of the location being tracked 160 is in an overlapping region of the three circles.

Other techniques can be used been used to improve estimates by reducing the overlap effect caused by the noise. One technological problem is that each technique introduces its own limitation. For example, the clustering technique is never extremely accurate. The linear regression technique is not robust against noise and suffers as the spread across each dimension is small, such as if multiple distance measuring devices lie on the same axis. A non-linear regression is computationally expensive. Another technological problem is that there does not exist a location tracking device that provides most accurate, low-noise, low power consumption performance across multiple environments. In some environments, one technique may be better performing, while in another environments, another technique may be better.

Described herein is a location tracking system and method improving existing object tracking techniques by utilizing a windowing routine along with a number of different algorithms and combining the different algorithms to overcome the limitations in each algorithm and improve the accuracy of the trilateration tracking technique. The disclosed embodiments provide a technological solution to overcome the weaknesses of each technique. The disclosed embodiments provide a further technological solution to improve location tracking performance across multiple environments.

In some embodiments, the location tracking system combines algorithms from different satellite navigation systems. For example, a first algorithm may be an algorithm used in GPS, a second algorithm may be an algorithm used in Globalnaya Navigazionnaya Sputnikovaya Sistema (GLONASS), and a third algorithm may be an algorithm used in Gallileo. In some embodiments, raw data used to determine an optimal combination of algorithms comes from different positioning systems. For example, a first set of raw data may come from reading a GPS system and a second set of raw data may come from using a sextant and/or using dead reckoning.

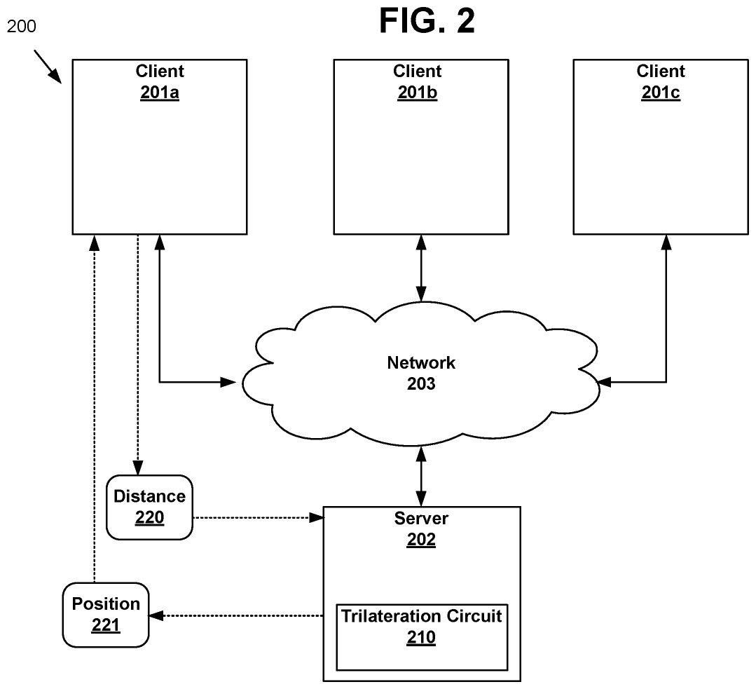

FIG. 2 illustrates an embodiment of a centralized location tracking system 200. Additional, fewer, or different structures may be included depending on the implementation. The centralized location tracking system 200 includes client devices 201a-c and a server device 202. The client devices 201a-c and the server device 202 are communicatively coupled to each other via a network 203. The server 202 includes a trilateration circuit 210 that is configured to receive a plurality of distance measurements 220 from the client devices 201a-c. In some embodiments, each distance measurement of the plurality of distance measurements 220 may include multiple raw data samples. Each of the multiple raw data samples may be measured at a different time. The purpose for receiving the multiple raw data samples is to improve the accuracy of the data.

In some embodiments, the trilateration circuit 210 may select a subset of the raw data samples from each client device. The process of selecting a subset is referred to as windowing and selecting a window herein. One purpose of windowing is to have a sample size large enough to reduce the effect of data outliers on certainty of the final position 221. Another purpose of windowing is to reduce the sample size from an initial sample size of the raw data in order to reduce a time lag in finding the final position 221. The time lag degrades real-time nature of the location tracking, and the real-time location tracking is important in critical applications such as firefighting. The selected window of the raw data samples may be used by the trilateration circuit 210 to compute a position via a location tracking algorithm.

In some embodiments, the trilateration circuit 210 may test an exact fit solution based on the raw data samples. If the exact fit solution is found, the trilateration circuit 210 may assign the exact fit solution as a final position 221. Finding an exact fit solution indicates that an environment is noiseless or has a negligible amount of noise. Therefore, other algorithms which improve location tracking in the presence of noise are not needed.

The trilateration circuit 210 is further configured to determine a first position, a first certainty level, and a first weight in a first environment using a first algorithm based on the plurality of distance measurements 220 received from the client devices 201a-c. The position may be referred to as solution herein. The trilateration circuit 210 is further configured to determine a second position, a second certainty level, and a second weight using a second algorithm based on the plurality of distance measurements 220 received from the client devices 201a-c. Although use of two algorithms is embodied here, the trilateration circuit 210 may use more or less than two algorithms. In some embodiments, determining the positions, the certainty levels, and the weights may be in response to not finding an exact fit solution. Each of the certainty levels indicates how with how much certainty the corresponding position is calculated. For example, in a noiseless system, the certainty level of an exact fit solution is 100%. In a noiseless system, where there is an overlap between the trilateration circles as illustrated in FIG. 1B, a solution based on the intersection of circles will have less than 100% certainty. As the overlap increases, the certainty level decreases. The certainty level may be referred to as a confidence level herein.

The first weight is determined based on the first certainty level and the second weight is determined based on the second certainty level. In one embodiment, the weight may be equal to the certainty level. In another embodiment, the weight may be converted from percentage to absolute by dividing the certainty level by 100. In yet another embodiment, the weight may be proportional to the certainty level and a sum of the weights may be equal to one. The weight will determine how strong the position associated with the weight influences the final position.

The trilateration circuit 210 is further configured to calculate the final position 221 based on the first position, the second position, the first weight, and the second weight. Although the following embodiments assume a one-dimensional system (e.g. a one-coordinate system), it is understood that the following applies to each coordinate in a multi-dimensional system (e.g. a multiple-coordinate system). In one embodiment, the final position 221 may be calculated by multiplying the first position by the first weight to determine a first weighted position, multiplying the second position by the second weight to determine a second weighted position, summing the first weighted position and the second weighted position to determine a combined position, and dividing by the combined position by a sum of the first weight and the second weight to determine the final position 221. The purpose of multiplying the positions by their respective weights is to favor the position that has a higher certainty level than the certainty level of the other positions. The trilateration circuit 210 that is further configured to send the final position 221 to the client devices 201a-c.

In some embodiments, the trilateration circuit 210 will update the previous weights to calculate a new final position in a second environment using the same set of algorithms used in the first environment. An embodiment of the new final position in the second environment may be the final position 221 in FIG. 2. The first environment may be a well-controlled environment and the second environment may be a less controlled environment where the location tracking becomes critical, such as inside a burning building that fire fighters are responding to. The purpose of collecting the plurality of distance measurements in the first well-controlled environment is to determine initial weights that are reliable. The trilateration circuit 210 may be configured to calculate a third position, a corresponding third level of confidence which determines a third weight, a fourth position, and a corresponding fourth level of confidence which determines a fourth weight. The trilateration circuit 210 may update the first weight based on the third weight and may update the second weight based on the fourth weight. For example, the updated first weight may be calculated by a weighted moving average. The implementation of the weighted moving average is achieved by multiplying the first weight by an old weight coefficient (e.g. that is greater than 0.5) to arrive at a first product, multiplying the third weight by a new weight coefficient (e.g. that is less than 0.5) to arrive a second product, and summing the first product and the second product. In this example, a sum of the old weight coefficient and the new weight coefficient are equal to one. The purpose of having a weighted moving average is to implement live updates of the first weight when changing from the first environment to the second environment. In some embodiments, the old weight coefficient is larger than the new weight coefficient to prevent wild fluctuations of the first weight when changing from the first environment to the second environment. The trilateration circuit 210 may calculate the new final position of the second environment based on the third position, the fourth position, the updated first weight and the updated second weight.

In another embodiment, the trilateration circuit 210 may determine the weights in the second environment independently of the weights in the first environment. In this regard, independence from the previous weights of the previous environments may improve accuracy of the weights in the second environment. In yet another embodiment, the weights in each environment after the first environment may only have dependence on the weights in the first environment. In this regard, there can be minimum dependence while still avoiding the wild fluctuations of the weights.

In some embodiments, the trilateration circuit may tailor each of the individual algorithms give optimal performance based on the certainty level rather than its overall accuracy (e.g. the algorithm is not maximized to always be as accurate as it can across all conditions but to give a better certainty level when its operating in a particular area to give a better overall combined result). This means that the algorithms are tuned to give best performance when operating as part of the collective set of algorithms.

An example of one of the algorithms used by the trilateration circuit 210 is clustering. This approach calculates the intersection points for each of the distance spheres and estimates the location based on clustering the estimations and taking the center of the cluster as the estimate. Clustering itself has many different optimization options with the final result being a position estimation that is robust to noise but never extremely accurate. This approach has the effect of spreading the effect of noise across all 3 dimensions.

Another example of one of the algorithms used by the trilateration circuit 210 is linear regression. This approach uses a direct solver. It deals with noise in each of the dimensions separately so this approach can be very accurate (especially in a single dimension) but is not robust against noise and also suffers as the spread across each dimension is small, e.g. if the samples portion of a given dimension are similar numbers (as in close to the same plane).

Another example of one of the algorithms used by the trilateration circuit 210 is non-linear regression. This approach can be used in two ways. A closed loop estimation of the non-linear solution or an open loop iterative solver that looks for the local best fit for the sample data in each access. This approach is more robust to noise and gives accurate results (more accurate in the iterative case) but is very processer expensive. This approach also suffers when the number of samples (distance measurements) is small which in many applications it is.

There is no limitation to a number of algorithms that the trilateration circuit 210 can use. For instance, the trilateration circuit 210 can use a combination of linear regression, non-linear regression and distance clustering. Additionally, the trilateration circuit 210 can include any distance matrix-based learning algorithm, e.g. multidimensional scaling (metric or non-metric) or any other manifold learning technique.

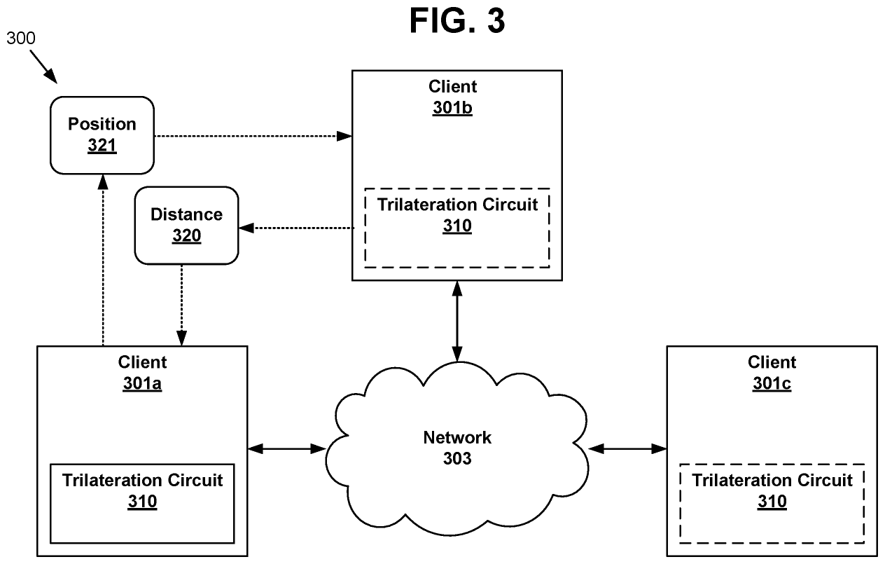

FIG. 3 illustrates an embodiment of a distributed location tracking system 300 in a distributed network. In some embodiments, the distributed location tracking system 300 is an ad-hoc network. Additional, fewer, or different structures may be included depending on the implementation. The distributed location tracking system 300 includes client devices 301a-c. The client devices 301a-c are communicatively coupled to each other through a network 303. The client devices 301a-c include trilateration circuit 310. In one embodiment, the trilateration circuit 310 may be the trilateration circuit 210 of FIG. 2.

The trilateration circuit 310 may be configured to perform the functions of the trilateration circuit 210 in FIG. 2. The trilateration circuit 310 of the client device 301a is configured to receive the plurality of distance measurements 320. A first part of the plurality of distance measurements 320 may be received from a distance measuring circuit within the client device 301a and a second part of the plurality of distance measurements 320 may be received from other client devices of the distributed network (e.g. the client devices 301b and 301c). In one embodiment, the plurality of distance measurements 320 may be the plurality of distance measurements 220 in FIG. 2. In some embodiments, the trilateration circuit may include a distance measuring circuit. The distance measuring circuit may be implemented as a computing device having a processor and memory. The distance measuring circuit may be implemented as software instructions in memory and executed by a processor. The trilateration circuit 310 of client device 301a is further configured to send the final position 321 to the other client devices of the distributed network. In one embodiment, the final position 321 may be the final position 221 in FIG. 2.

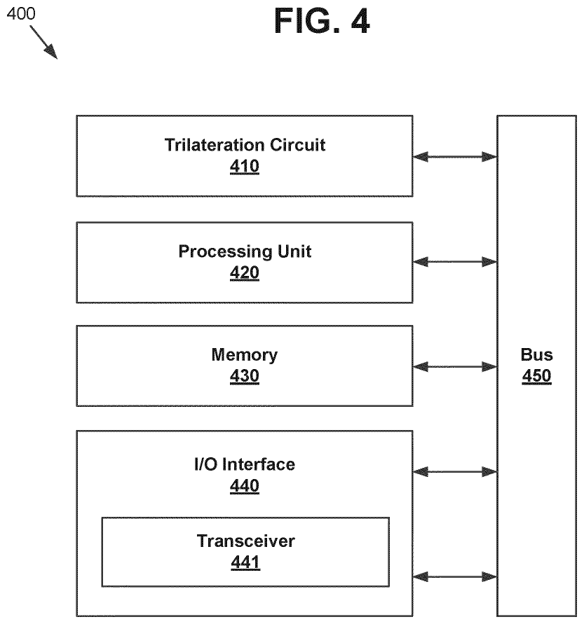

FIG. 4 illustrates an embodiment of a client device 400. Additional, fewer, or different structures may be included depending on the implementation. In one embodiment, the client device 400 may be an instance of the client device 301a in FIG. 3. The client device 400 includes a trilateration circuit 410 coupled to a bus 450. In one embodiment, the trilateration circuit 410 is an instance of the trilateration circuit 310 in FIG. 3. The trilateration circuit 410 may be implemented as a computing device having a processor and memory. The trilateration circuit 410 may be implemented as software instructions in memory and executed by a processor. In some embodiments, the client device 400 may further include a memory 430, and an input/output (“I/O”) interface 440, all of which may be coupled to each other via the bus 450.

The processing unit 420 is configured to execute one or more sequences of one or more instructions contained in the memory 430. The memory 430 includes non-volatile media and volatile media. Examples of non-volatile media are optical disks, magnetic disks, hard disk drive (“HDD”), and/or solid state disk (“SSD”). The non-volatile media comprise programmable read-only memory (“PROM”), erasable programmable read-only memory (“EPROM”), and/or flash memory. Examples of volatile media are cache memory, main memory, and/or system memory. The volatile media may comprise read-only memory (“RAM”), dynamic read-only memory (DRAM), and/or static read-only memory (“SRAM”). The memory 430 is configured to store instructions that are executed by the processing unit 420. In some embodiments, the memory 430 may be configured to store instructions that are executed by the trilateration circuit 410. In some embodiments, the trilateration circuit will store the positions, the certainty levels, and the weights for various tracked locations on the memory 430.

The I/O interface 440 is configured to interface communication between the client devices and other hardware. The I/O interface includes a transceiver 441. The I/O interface may further include a modem, an Ethernet card, a peripheral component interconnect express (“PCIe”) card, a network interface controller (“NIC) for communicating with a wire-based network, a wireless NIC (“WNIC”) for communicating with a wireless network such as WI-FI, display, and/or input devices. In particular embodiments, the client device 400 may include one or more of any such components.

The wireless transceiver 441 is configured to send and receive sensor data. The transceiver 441 is configured to send data, including the final position 321, from the trilateration circuit 410 to the other client devices. The transceiver 441 is also configured to receive the plurality of distance measurements 320 from the other client devices and send the plurality of distance measurements 320 to the trilateration circuit 410. In some embodiments, the transceiver 441 may be a zero-intermediate-frequency (“zero IF”) transceiver. The zero IF transceiver typically consumes less power than other wireless transceiver architectures. In other embodiments, the transceiver 441 architecture may be super-heterodyne, low-IF, slide-IF, or super-regenerative. In some embodiments, the transceiver 441 may be coupled to a modem. The modem modulates and demodulates modulated signals such as ASK, FSK, and PSK.

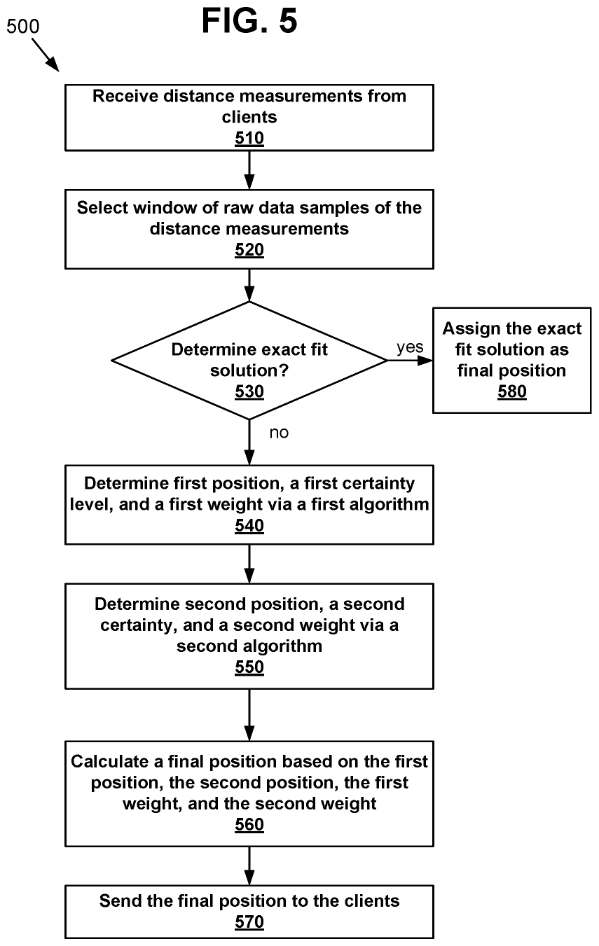

FIG. 5 illustrates an example method 500 of combining different trilateration techniques. Additional, fewer, or different steps may be included depending on the implementation. The method 500 may be implemented by the trilateration circuit 310. Although use of two algorithms is embodied here, the trilateration circuit 310 may use more or less than two algorithms. The trilateration circuit 310 can use a combination of linear regression, non-linear regression distance clustering, any other distance matrix-based learning algorithm, or any other manifold learning technique.

At operation 510, the trilateration circuit 310 receives the plurality of distance measurements 320 from a plurality of client devices. The plurality of distance measurements 320 include raw data samples. At operation 520, the trilateration circuit 310 selects a window of the raw data samples of the plurality of distance measurements 320. At operation 530, the trilateration circuit 310 determines if there is an exact fit solution to the windowed data. If the exact fit solution is found, then at operation 580, the trilateration circuit 310 assigns the exact fit solution as the final position 321. If the exact fit solution is not found, then at operation 540, the trilateration circuit 310 determines a first position, a first certainty level, and a first weight based on the plurality of distance measurements 320 via a first algorithm. At operation 550, the trilateration circuit 310 determines a second position, a second certainty level, and a second weight based on the plurality of distance measurements 320 via a second algorithm. At operation 560, the trilateration circuit 310 calculates the final position 321 based on the first position, the second position, the first weight, and the second weight. In one embodiment, the trilateration circuit 310 determines a third position, a third certainty level, and a third weight based on the plurality of distance measurements 320 via a third algorithm. The trilateration circuit 310 may calculate the final position 321 based on the first position, the second position, the third position, the first weight, the second weight, and the third weight. At operation 570, the trilateration circuit 310 sends the final position 321 to the plurality of client devices.

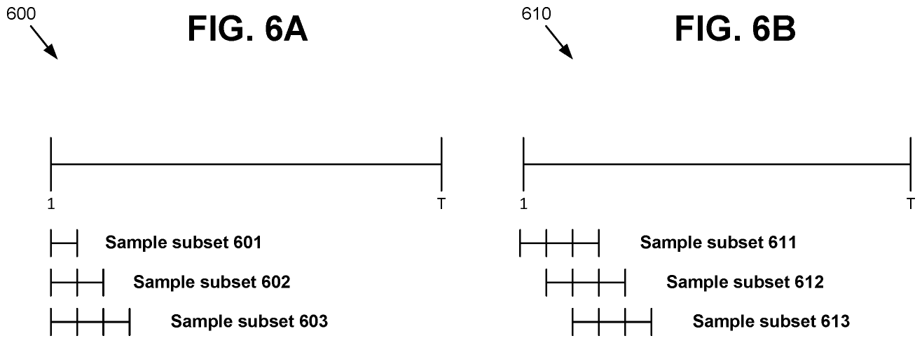

FIG. 6A graphically illustrates subsets of raw data samples 600, each having a different size. Sample subset 601 has 2 data samples. Sample subset 602 has 3 data samples, and sample subset 603 has four data samples. FIG. 6B graphically illustrates subsets of raw data samples 610, each having a different starting sample. Sample subset 611 starts at the first raw data sample. Sample subset 612 starts at the second raw data sample. Sample subset 613 starts at the third raw data sample.

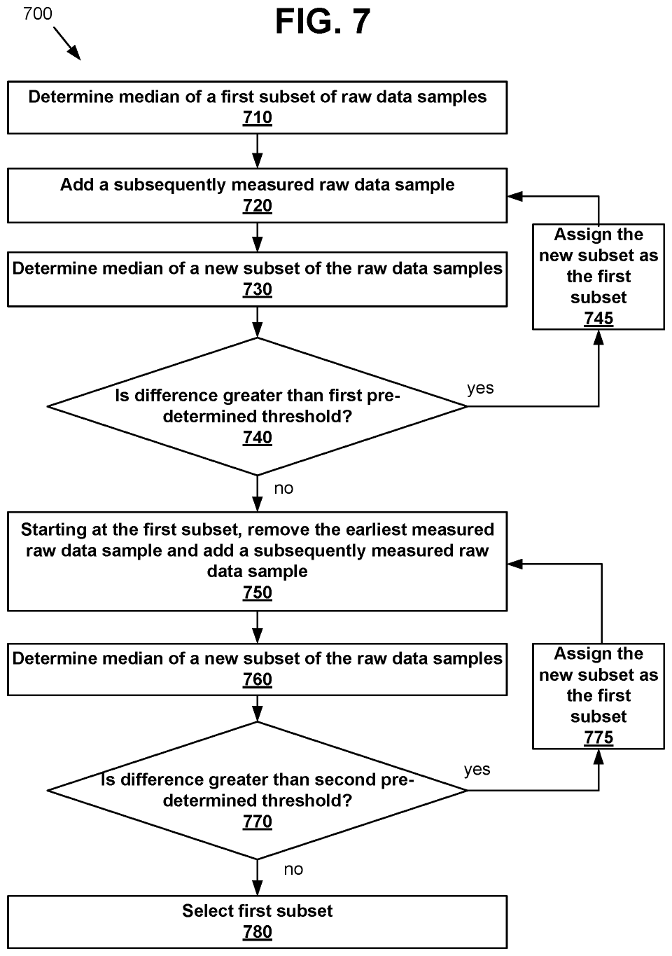

FIG. 7 illustrates an example method 700 of windowing. Additional, fewer, or different steps may be included depending on the implementation. The method 700 may be implemented by the trilateration circuit 310. At operation 710, the trilateration circuit 310 determines a first median of a first subset of raw data samples. One embodiment of the raw data samples in FIG. 7 may be the raw data samples in FIG. 5. A subset may be referred to as a window herein. At operation 720, the trilateration circuit 310 adds a subsequently measured data sample to the first subset to generate a second subset of the raw data samples. Thus, for example, if the first subset is the sample set 601, then the second subset is the sample set 602. At operation 730, the trilateration circuit 310 determines a second median of the second subset of the raw data samples. At operation 740, the trilateration circuit 310 determines whether a difference between the first median and the second median is greater than a first predetermined threshold. If the difference between the first median and the second median is greater than the first predetermined threshold, then at operation 745, the trilateration circuit 310 assigns the second subset as the first subset and returns to operation 720.

If the difference between the first median and the second median is less than the first pre-determined threshold, then at operation 750, the trilateration circuit 310 removes the earliest measured raw data sample in the first subset and adds a subsequently measured data sample to the first subset to generate a third subset of the raw data samples. Thus, for example, if the first subset is sample set 611, then the third subset is sample set 612. At operation 760, the trilateration circuit 310 determines a third median of the third subset of the raw data samples. At operation 770, the trilateration circuit 310 determines whether a difference between the first median and the third median is greater than a second predetermined threshold. If the difference between the first median and the third median is greater than the second predetermined threshold, then at operation 775, the trilateration circuit 310 assigns the third subset as the first subset and return to operation 750. If the difference between the first median and the third median is less than the second pre-determined threshold, then at operation 780, the trilateration circuit 310 selects the first subset of the raw data samples.

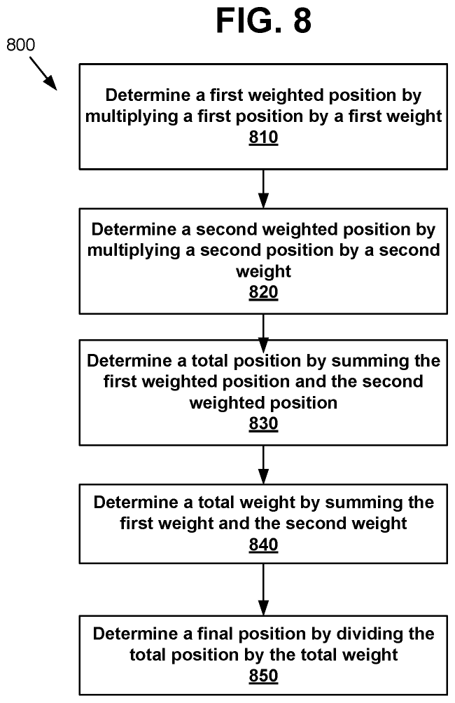

FIG. 8 illustrates an example method 800 of calculating the final position 321. Additional, fewer, or different steps may be included depending on the implementation. The method 800 may be implemented by the trilateration circuit 310. At operation 810, the trilateration circuit 310 determines a first weighted position by multiplying a first position by a first weight. At operation 820, the trilateration circuit 310 determines a second weight position by multiplying a second position by a second weight. At operation 830, the trilateration circuit 310 determines a total position by summing the first weighted position and the second weighted position. At operation 840, the trilateration circuit 310 determines a total weight by summing the first weight and the second weight. At operation 850, the trilateration circuit 310 determines the final position 321 by dividing the total position by the total weight

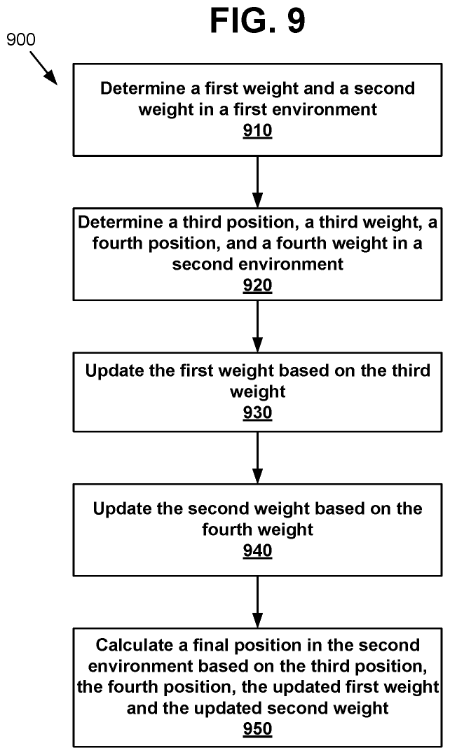

FIG. 9 illustrates an example method 900 of using weights of a first environment in a second environment. Additional, fewer, or different steps may be included depending on the implementation. The method 900 may be implemented by the trilateration circuit 310. At operation 910, the trilateration circuit 310 determines a plurality of base weights including a first weight and a second weight in a first environment. At operation 920, the trilateration circuit 310 determines a third position, a third weight, a fourth position, and a fourth weight in a second environment. In some embodiments, the third position and the third weight may be determined via a same first algorithm that determined the first position and the first weight. In some embodiments, the fourth position and the fourth weight may be determined via a same second algorithm that determined the second position and the second weight. At operation 930, the trilateration circuit 310 updates the first weight based on the third weight. At operation 940, the trilateration circuit 310 updates the second weight based on the fourth weight. At operation 950, the trilateration circuit 310 calculates a final position in the second environment based on the third position, the fourth position, the updated first weight and the updated second weight. In some embodiments, the final position in the second environment may be the final position 321. In some embodiments, the calculation in the operation 950 is performed using the operations in the example method 800.

What is claimed is:

1. A trilateration system comprising:
a plurality of client devices distributed across a first environment and configured to generate a plurality of base distance measurements;
a plurality of wireless transceivers, each of the plurality of transceivers coupled to one of the plurality of client devices, the plurality of transceivers configured to send and receive base distance measurements; and
a trilateration circuit in at least one of the plurality of client devices, the trilateration circuit configured to:
receive the plurality of base distance measurements from the plurality of client devices in the first environment;
determine a first position and a first weight based on the plurality of base distance measurements via a first algorithm;
determine second position and a second weight based on the plurality of base distance measurements via a second algorithm;
calculate a final position based on the first position, the second position, the first weight, and the second weight; and
send the final position to the plurality of client devices.

2. The system of claim 1, wherein the determining the first position and determining the second position are in response to determining an absence of an exact fit solution.

3. The system of claim 1, wherein the first weight is based on a first certainty level, and wherein the second weight based on a second certainty level.

4. The system of claim 3, wherein the first weight is proportional to the first certainty level, wherein the second weight is proportional to the second certainty level, and wherein a sum of the first weight and the second weight is equal to a value of one.

5. The system of claim 1, the trilateration circuit further configured to:
receive a plurality of live distance measurements from a plurality of second client devices distributed across a second environment;
determine a third position and a third weight via the first algorithm;
determine a fourth position and a fourth weight via the second algorithm;
update the first weight based on the third weight;
update the third weight based on the fourth weight; and
calculate a second final position of the second environment based on the third position, the fourth position, the updated first weight and the updated second weight.

6. The system of claim 1, wherein the plurality of base distance measurements comprises raw data samples of a first one of the plurality of client devices, wherein each of the raw data samples are measured at different times, and wherein the trilateration circuit is further configured to select a window of the raw data samples in response to receiving the raw data samples from the first one of the plurality of client devices.

7. The system of claim 6, wherein the selecting the window of the raw data samples comprises:
determining a first median value of a first subset of the raw data samples;
determining a second median value of a second subset of the raw data samples; and
in response to a difference between the second median value and the first median value being less than a pre-determined value, selecting from the first one of the plurality of client devices only the first subset of the raw data samples.

8. The system of claim 1, wherein the calculating comprises:
determining a first weighted position by multiplying the first position by the first weight;
determining a second weighted position by multiplying the second position by the second weight; and
calculating a sum of the first weighted position and the second weighted position.

9. The system of claim 1, wherein the first algorithm comprises a clustering algorithm and the second algorithm comprises a linear regression algorithm.

10. A trilateration method comprising:
receiving, by a trilateration circuit, a plurality of base distance measurements from a plurality of client devices distributed across a first environment;
determining, by the trilateration circuit, a first position and a first weight based on the plurality of base distance measurements via a first algorithm;
determining, by the trilateration circuit, a second position and a second weight based on the plurality of base distance measurements via a second algorithm;
calculating, by the trilateration circuit, a final position based on the first position, the second position, the first weight, and the second weight; and
sending, by the trilateration circuit, the final position to the plurality of client devices.

11. The method of claim 10, wherein the determining the first position and determining the second position are in response to determining an absence of an exact fit solution.

12. The method of claim 10, wherein the first weight is based on a first certainty level, and wherein the second weight is based on a second certainty level.

13. The method of claim 12, wherein the first weight is proportional to the first certainty level, wherein the second weight is proportional to the second certainty level, and wherein a sum of the first weight and the second weight is equal to a value of one.

14. The method of claim 10, further comprising:
receiving, by the trilateration circuit, a plurality of live distance measurements from a plurality of second client devices in a second environment;
determining, by the trilateration circuit, a third position and a third weight via the first algorithm;
determining, by the trilateration circuit, a fourth position and a fourth weight via the second algorithm;
updating, by the trilateration circuit, the first weight based on the third weight;
updating, by the trilateration circuit, the third weight based on the fourth weight; and
calculating, by the trilateration circuit, a second final position based on the third position, the fourth position, the updated first weight and the updated second weight.

15. The method of claim 10, wherein the plurality of base distance measurements comprises raw data samples of a first one of the plurality of client devices, wherein each of the raw data samples are measured at different times, and wherein the method further comprises selecting a window of the raw data samples in response to receiving the raw data samples from the first one of the plurality of client devices.

16. The method of claim 15, wherein the selecting the window of the raw data samples comprises:
determining a first median value of a first subset of the raw data samples;
determining a second median value of a second subset of the raw data samples; and
in response to a difference between the second median value and the first median value being less than a pre-determined value, selecting from the first one of the plurality of client devices only the first subset of the raw data samples.

17. The method of claim 10, wherein the calculating comprises:
determining a first weighted position by multiplying the first position by the first weight;
determining a second weighted position by multiplying the second position by the second weight; and
calculating a sum of the first weighted position and the second weighted position.

18. The method of claim 10, wherein the first algorithm comprises a clustering algorithm and the second algorithm comprises a linear regression algorithm.

19. A trilateration system comprising:
a plurality of client devices distributed across a first environment and configured to generate a plurality of base distance measurements;
a plurality of wireless transceivers, each of the plurality of transceivers coupled to one of the plurality of client devices, the plurality of transceivers configured to send and receive base distance measurements; and
a trilateration circuit in at least one of the plurality of client devices, the trilateration circuit configured to:
receive the plurality of base distance measurements from the plurality of client devices in the first environment;
determine a plurality of positions and a plurality of weights based on the plurality of base distance measurements via a plurality of algorithms;
calculate a final position based on the plurality of positions and the plurality of weights; and
send the final position to the plurality of client devices.

20. The system of claim 19, wherein the determining the plurality of positions is in response to determining an absence of an exact fit solution.
